(19) United States
(12) Patent Application Publication
(10) Pub. No.: US 2015/0219321 A1
(43) Pub. Date: Aug. 6, 2015

(54) A CONNECTOR FOR FITTING AND LOCKING FLEXIBLE LIGHT EMITTING TUBES AND LUMINOUS IDENTIFICATION DEVICES

(71) Applicant: Michael Arie lVARDI, (US)

(72) Inventor: Michael Ariel Vardi, Herzeliya (IL)

(21) Appl. No.: 14/420,710

(22) PCT Filed: Aug. 8, 2013
(86) PCT No.: PCT/IL2013/050676

§ 371 Date: Feb. 10, 2015

Related U.S. Application Data
(60) Provisional application No. 61/682,236, filed on Aug. 11, 2012.

(51) Int. Cl. F21V 19/00; F21K 2/06

(52) U.S. Cl. CPC F21V 19/0075; F21K 2/06; F21Y 2103/022

(57) ABSTRACT

The invention is a connector for connecting, fitting to size, and locking a flexible light emitting tube into a loop having a generally circular or U shape so that it can be used, for example as a wrist or ankle bracelet, necklace, or other wearable accessory such as a belt or shoelace or that can be wrapped around a post or other object. In another aspect the invention is a luminous identification device comprised of a connector and flexible light emitting tube bent into a loop whose circumference can be adjusted.

### CROSS-REFERENCE TO RELATED APPLICATION(S)

The present patent application/patent claims the benefit of priority of PCT Patent Application No. PCT/IL2013/050676, filed on Aug. 8, 2013, and entitled “A CONNECTOR FOR FITTING AND LOCKING FLEXIBLE LIGHT EMITTING TUBES AND LUMINOUS IDENTIFICATION DEVICES,” the contents of which are incorporated in full by reference herein. The present patent application/patent claims also the benefit of priority of U.S. Provisional Patent Application No. 61/937,967, filed on Feb. 10, 2014, and entitled “AN APPARATUS FOR DIRECT USER MARKETING AND USER ENGAGEMENT,” the contents of which are incorporated in full by reference herein.

### FIELD OF THE DISCLOSURE

The invention is from the field of devices used for illumination and to identify individuals and objects. More specifically it relates to the use of flexible light emitting tubes used for entertainment, to identify members of subgroups of persons in a larger group of individuals and for use as access control aides in closed venues, for emergency lighting, and many other applications.

### BACKGROUND OF THE DISCLOSURE

Glow sticks are hollow plastic tubes that contain at least two different chemicals that when mixed together produce light by chemiluminescence. The emitted light can be selected from a wide variety of colors depending on the chemicals used. The light produced is generally relatively short-lived, typically from a couple of hours to several hours or more. Because no external energy source is needed and they are inexpensive and waterproof glow sticks are used as emergency light sources by police, firemen, military forces, campers, and divers. By far the most extensive use of glow sticks is for entertainment. They are an indispensable feature of parties, dances, and concerts.

When produced as flexible tubes glow chemiluminescent products can be used as clothing accessories, i.e. bracelets or necklaces, by bending them in a circle and connecting the two ends of the plastic tube together. U.S. Pat. No. 6,840,648, U.S. Pat. No. 4,317,337, and US 2006/0262531 are examples of patent documents that teach connectors for performing this function. The connectors described in these publications all connect the ends of the tubes end-to-end. That is when the glow stick is held in a circular configuration with these connectors, the entire structure, tube and connector lies in a plane. There is no provision made for adjusting the circumference of the circle. Since the plastic tube cannot be shortened, the circumference of the resulting necklace or bracelet is essentially equal to the length of the glow stick from which it is fabricated.

It is a purpose of the present invention to provide a connector for connecting two ends of a light emitting tube, such as a glow stick, to form a closed loop having a generally circular or U shape whose circumference can be made shorter than the length of the light emitting tube.

It is another purpose of the present invention to provide a connector having a locking member such that when the ends of a light emitting tube, such as a glow stick, are inserted into the connector they cannot be removed without destroying either the connector or the light emitting tube.

Further purposes and advantages of this invention will appear as the description proceeds.

### BRIEF SUMMARY OF THE DISCLOSURE

In a first aspect the invention is a connector for connecting, fitting to size, and locking a flexible light emitting tube into a closed loop that is fit around an object. The connector comprises:
a first side section comprising a bore having at least one open end and a locking element located in the bore;
a second side section comprising a bore having two open ends and a locking element located in the bore; and
a connecting section adapted to join the first and the second side sections together.
   The connector of the invention is characterized in that, when a first end of the flexible light emitting tube is inserted into, through, and locked by the locking element in the bore in the first side section, a second end of the flexible light emitting tube can be pushed through the bore in the second side section, thereby reducing the length of the circumference of the loop enabling the loop to fit securely around the object.

In embodiments of the connector of the invention, the second end of the flexible light emitting tube is pushed through the bore in the second side section in the opposite direction to which the first end of the flexible light emitting tube was inserted into the bore in the first side section, thereby creating a loop having a helical shape. In embodiments of the connector of the invention, the second end of the flexible light emitting tube is pushed through the bore in the second side section in the same direction to which the first end of the flexible light emitting tube was inserted into the bore in the first side section, thereby creating a loop having a U shape.

Embodiments of the connector of the invention are manufactured from a material that is sufficiently strong such that once the respective ends of the flexible light emitting tube have passed through the locking elements in the respective bores in the first and second side section and the loop is fit securely around the object, the length of the circumference of the loop cannot be increased without destroying the connector, thereby preventing the connector from being reused.

Embodiments of the connector of the invention are manufactured such that the connecting section can be separated from the side sections without the use of tools. In these embodiments the separated connecting section is retained by participants as a souvenir of the event that was attended.

In embodiments of the connector of the invention, the two side sections and connecting section are elongated and displaced from each other in the axial direction.

Embodiments of the connector of the invention comprise information created on or attached to the surface or embedded in the connecting section. In these embodiments at least a part of the information can be embodied in a radio communication technology component. In these embodiments the radio communication technology can be Near Field Communication (NFC) or Radio Frequency Identification (RFID).

In a second aspect the invention is a luminous identification device comprised of a flexible light emitting tube and a connector adapted to hold the flexible light emitting tube in a loop. The connector comprises:
a first side section comprising a bore having at least one open end and a locking element located in the bore;
a second side section comprising a bore having two open ends and a locking element located in the bore; and
a connecting section adapted to join the first and the second side sections together.
   The luminous identification device of the invention is characterized in that, when a first end of the flexible light emitting tube is inserted into through and locked by the locking element in the bore in the first side section, a second end of the flexible light emitting tube can be pushed through the bore in the second side section, thereby reducing the length of the circumference of the loop enabling the loop to fit securely around an object. The luminous identification device of the invention can be adapted to be used as a single use payment verification and identification means.

Embodiments of the luminous identification device of the invention can comprise at least two flexible light emitting tubes connected by one connector for each of the at least two tubes. All the above and other characteristics and advantages of the invention will be further understood through the following illustrative and non-limitative description of embodiments thereof, with reference to the appended drawings.

### BRIEF DESCRIPTION OF THE DRAWINGS

FIG. 1 schematically shows an embodiment of the connector of the invention;

FIG. 2 schematically shows a flexible light emitting tube held in a helical configuration by the connector shown in FIG. 1;

FIG. 3 schematically shows a flexible light emitting tube held in a U-shaped configuration by a connector of the invention;

FIGS. 4A, 4B, and 4C schematically show how a unidirectional locking element locks the flexible light emitting tube in the bore of the side section of a connector of the invention;

FIGS. 5A, 5B, and 5C schematically show how a bidirectional locking element locks the flexible light emitting tube in the bore of the side section of a connector of the invention;

FIG. 6 symbolically shows an embodiment of the connector designed to enhance the lighting effect in the connecting section for purposes of displaying information;

FIG. 7 schematically shows an embodiment of connector of the invention in which the two side sections and connecting section are elongated and displaced from each other in the axial direction;

FIG. 8 symbolically shows an embodiment of the connector of the invention in which the connecting section can be separated in one piece from the two side sections;

FIGS. 9-12 show a system for long-term direct marketing and user engagement; and

FIG. 13 schematically shows an embodiment of the invention in which the connecting section contains mechanically weak area allowing a single handed force on the bores to separate them and tactile markings to indicate the direction of insertion.

### DETAILED DESCRIPTION OF THE DISCLOSURE

The invention is a connector for connecting, fitting to size, and locking a flexible light emitting tube into a loop having a generally circular or U shape so that it can be used, for example as a wrist or ankle bracelet, necklace, or other wearable accessory such as a belt or shoelace or that can be wrapped around a post or other object. In another aspect the invention is a luminous identification device comprised of a connector and flexible light emitting tube bent into a loop whose circumference can be adjusted.

Examples of flexible light emitting tubes that can be used with the connector of the invention are chemiluminescent stick-light tubes (aka glow-sticks, light-sticks) or flexible tubes comprising LEDs (Light Emitting Diodes). The flexible light emitting tubes of the invention can emit light in the entire visible range and also at infrared wavelengths for certain applications. Flexible tubes of these types are typically made from sections of relatively soft plastic tubing having smooth outer surfaces, both ends sealed, and interiors filled with the appropriate chemical or electronic components. Light emitting tubes of these types are used, for example, at parties, concerts, bars and discos, sporting events, and attached to objects in order to identify or locate them in the dark.

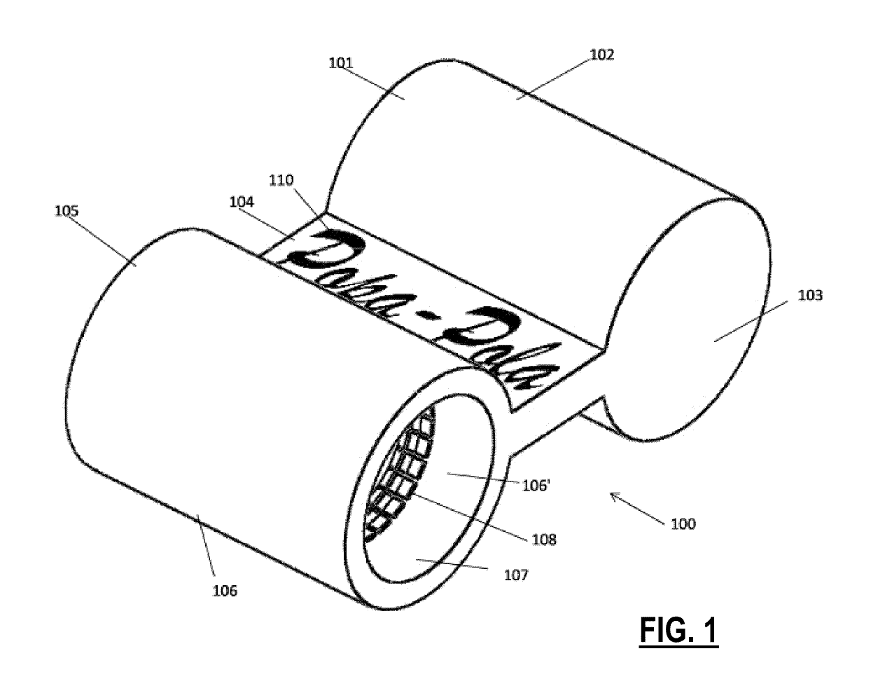

FIG. 1 schematically depicts an embodiment of the connector of the invention. Connector (100) is comprised of two side sections with a connecting section between them. A first side section (102) comprises a bore (102′) not seen in FIG. 1 comprising ends (101) and (103). In this embodiment bore (102′) has one open end (101) and one closed end (103). A second side section (106) comprises a bore (106′) having two open ends (105) and (107). Connecting section (104) may be either straight or curved and in embodiments may have information (110) e.g. an advertisement or logo printed, engraved, embedded in the form of a RFID/NFC component or otherwise created in it or on its surface. Also shown in FIG. 1 is a locking element (108) inside of bore (106′) in side section (106). A similar locking element (not shown in the figures) is located inside bore (102′) in side section (102).

Embodiments of the connector (100), such as those shown in FIGS. 1, 2, 3, 6, and 7, are manufactured from polyethylene or another commonly used plastic that is sufficiently strong to prevent the connector (100) from being broken apart without the use of a tool, e.g. scissors, cutter pliers, or knife. Embodiments of the connectors of the invention can either be manufactured as single pieces or from two or more pieces that are irreversibly connected together.

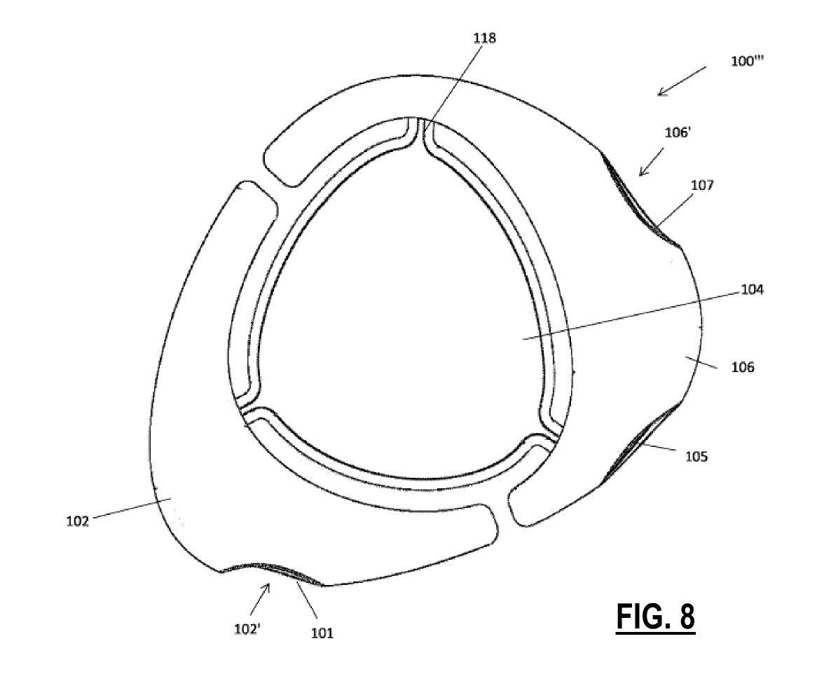

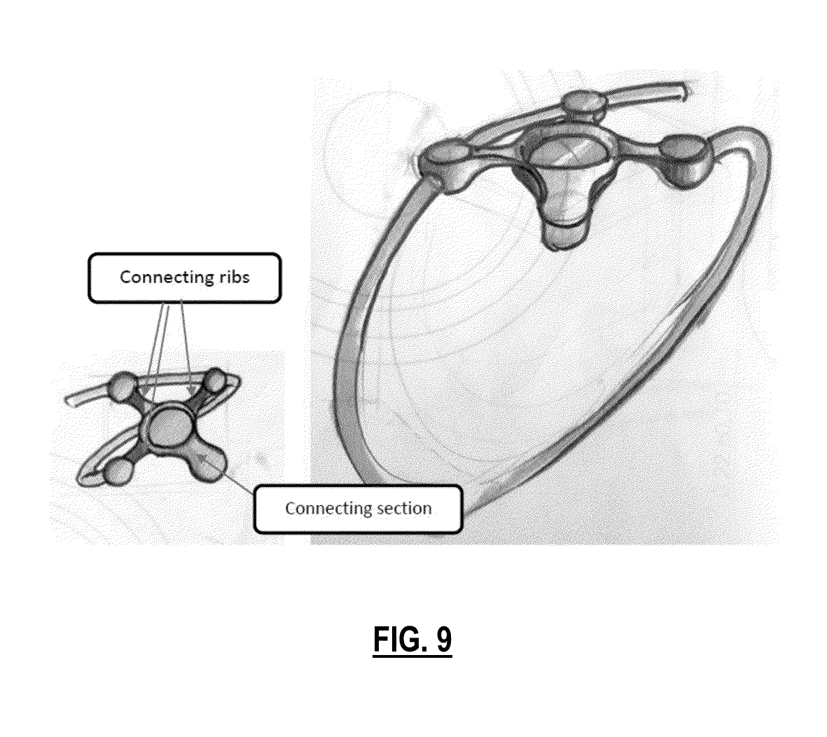

Other embodiments of the connector (100), such as that shown in FIG. 8, which is described herein below, are manufactured such that the connecting section can be easily separated from the side sections, in some embodiments without the use of tools. Each of the bores in the side sections has the same cross-sectional shape as the flexible light emitting tube, typically circular, and an inner diameter slightly larger than the outer diameter of a flexible light emitting tube, e.g. a flexible glow-stick tube (standard diameters are 4.9 mm, 5 mm or 6 mm).

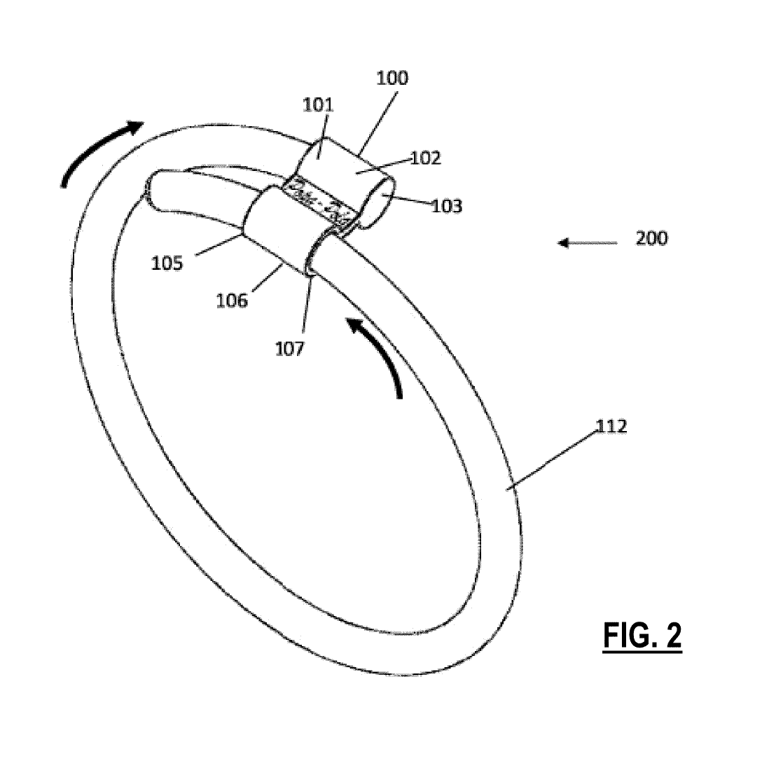

FIG. 2 schematically depicts a flexible light emitting tube (112) held in a circular loop (strictly speaking the three dimensional configuration is helical, but for simplicity it is frequently referred to as circular herein) by a connector (100) of the invention. To form helical-shaped identification device (200) a first end of flexible light emitting tube (112) is inserted into open end (101) of the bore (102′) in first side section (102) and pushed into the bore (102′) until the first end passes through the locking mechanism (108) and reaches the closed end (103). The second end of flexible light emitting tube (112) is inserted into open end (107) of the bore (106′) in the second side section (106) and pushed through the locking element (108) and out of the open end (105) of bore (106′) until the circumference of the loop reaches the desired value, e.g. until the light emitting tube fits securely around, for example the wrist of a user or a door handle or tree branch. In FIG. 2 and many of the other figures the bold arrows next to the flexible light emitting tube indicate the direction in which the tube is inserted into and pushed or pulled through the bore in the side section of the connector.

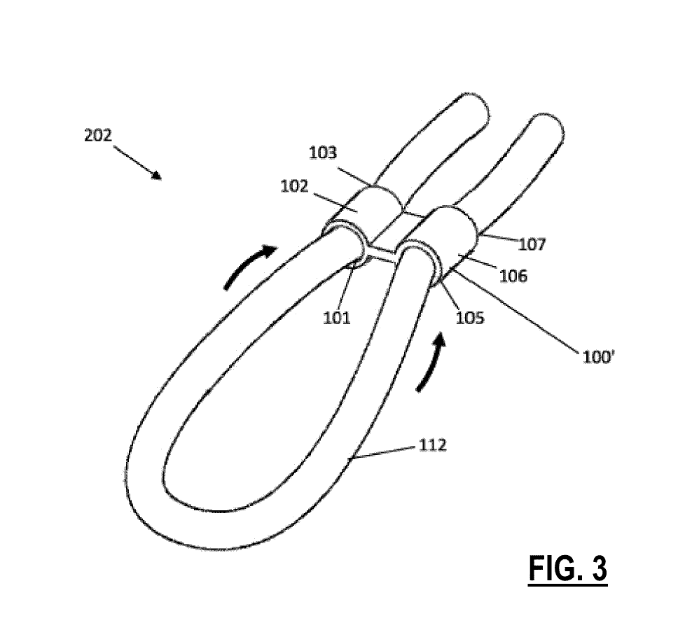

FIG. 3 schematically shows a flexible light emitting tube (112) held in a U-shaped loop by a connector (100′) of the invention. To form U-shaped identification device (202) a connector (100′) is used. Connector (100′) differs from connector (100) in that end (103) of side section (102) is open and not closed and that the locking elements 108 are adapted to allow the ends of the light emitting tube to be pushed in the same direction through the bores in both side sections of the connector. A first end of flexible light emitting tube (112) is inserted into open end (101) of the bore (102′) in first side section (102) and pushed into the bore (102′) until the first end passes through the locking mechanism (108) and exits through end (103). The second end of flexible light emitting tube (112) is inserted into open end (107) of the bore (106′) in the second side section (106) and pushed through the locking mechanism (108) and out of the open end (105) of bore (106′). Then one or both of the free ends of flexible light emitting tube (112) are pulled further through the respective bore until the circumference of the U-shaped loop is such that it fits securely around the object to which U-shaped identification device (202) is to be attached. This embodiment is sometimes advantageous when forming the band around a small object since there are two relatively short “tails” sticking out of both sides of the connector (100′) rather than one long “tail” sticking out of only one side.

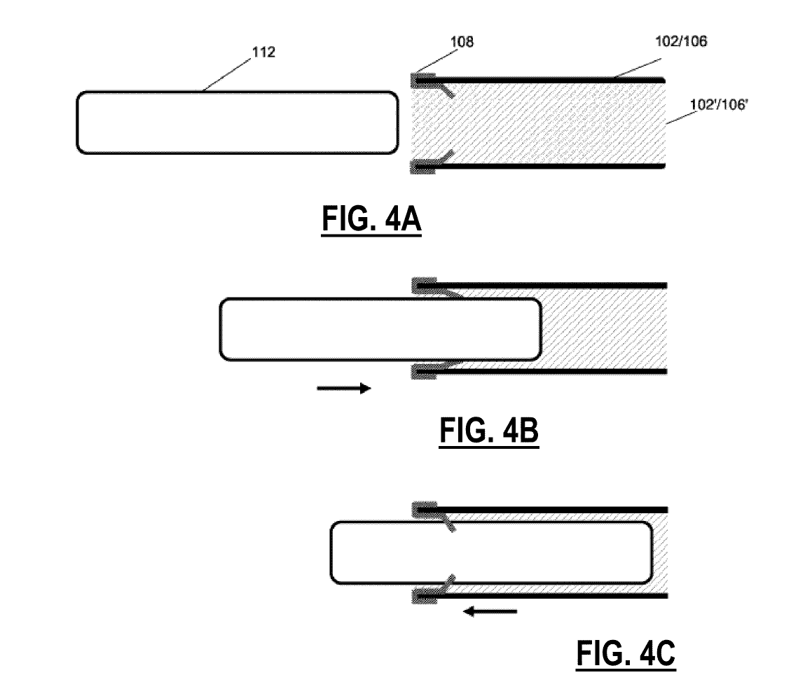

In the interior of the bore (102′) in the first side section (102) and of the bore (106′) in the second side section (106) is located a locking element (108). In the figures the locking element (108) is shown implemented as a circular array of locking teeth implemented in the bores; however other configurations containing one or more teeth can also be used. The locking teeth are made from resilient metal or rigid plastic material and have sharp ends. The locking elements can either be unidirectional, i.e. allow the flexible light emitting tube to be pushed through the bore in the side section of the connector in only one direction, or bidirectional, i.e. allow the flexible light emitting tube to be pushed through the bore in the side section of the connector in either direction. In both the unidirectional and the bidirectional embodiments, once the flexible light emitting tube has passed through a locking element it cannot be removed without applying so much force that irreversible damage will be caused to the connector or the flexible light emitting tube. FIGS. 4A, 4B, and 4C schematically show how the unidirectional locking element (108) locks the flexible light emitting tube (112) in the bore (1027106′) of the side section (102/106) of a connector of the invention. FIG. 4A shows a flexible light emitting tube (112) approaching the bore (1027106′). FIG. 4B shows how the teeth are pushed aside and slide over the soft outer surface of flexible light emitting tube 112 when it is pushed in the direction indicated by the bold arrow, thereby allowing the flexible light emitting tube (112) to be pushed through the interior of the bore (1027106′). FIG. 4C shows how when flexible light emitting tube 112 is pulled in the opposite direction (indicated by the bold arrow) the sharp ends of the teeth of unidirectional locking element (108) dig into the soft smooth outer surface of the tube, thereby preventing the flexible light emitting tube (112) from being pulled back through locking element (108) without damaging either the flexible light emitting tube (112), e.g. by the teeth piercing the walls of the light emitting tube causing leakage of the chemiluminescent fluid, or the teeth of unidirectional locking mechanism (108). Unidirectional locking elements (108) with the teeth oriented in opposite directions are located in bores (102′) and (106) in the connector (100) shown in FIG. 2. Once the end of flexible light emitting tube (112) has been pulled through the unidirectional locking element (108) in bore (106′) in the second side section (106) tightening it as required, for example around an individual's wrist, then the only way to remove the formed “bracelet” is to cut connecting section (104) with a cutting tool, e.g. scissors; thus destroying the apparatus and preventing it from being reused. It is noted that the “bracelet” can also be removed by cutting the flexible light emitting tube (112); however in view of possible adverse reactions to the chemicals in glow-sticks, this method of removing the “bracelet” is not recommended. Even if the flexible light emitting tube (112) is cut, the connector cannot be reused since part of the tube will still be locked by the teeth of the locking element in the first side (102) of connector (100) preventing a new tube from being inserted into the bores in the side sections. Also, once the flexible tube is cut and the chemicals leak out, the device loses its color and therefore its ability to be used as an identification device.

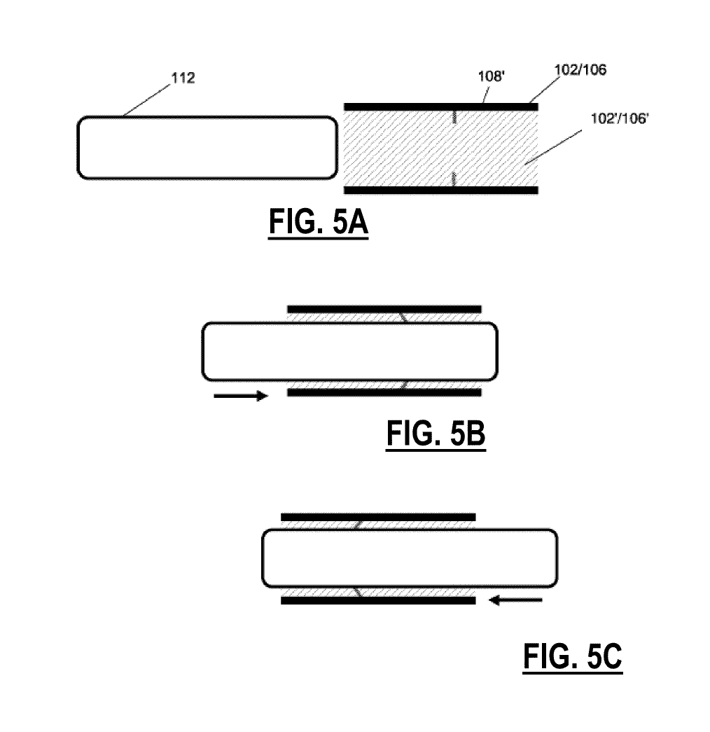

FIGS. 5 A, 5B, and 5C schematically show how the bidirectional locking element (108′) locks the flexible light emitting tube (112) in the bore (1027106′) of the side section (102/106) of a connector of the invention. FIG. 5A shows a flexible light emitting tube (112) approaching the bore (1027106′). FIG. 5B and FIG. 5C show how the teeth are pushed aside and slide over the soft outer surface of flexible light emitting tube 112 when it is pushed into the bore (1027106′) in either direction as indicated by the bold arrows, thereby allowing the flexible light emitting tube (112) to be pushed through the interior of the bore (1027106′). If, after it has passed through locking element (108′) as shown in FIGS. 5A and 5B, an attempt is made to pull flexible light emitting tube 112 in the opposite direction the sharp ends of the teeth of unidirectional locking element (108) dig into the soft smooth outer surface of the tube, thereby preventing the flexible light emitting tube (112) from being pulled back through locking element (108′).

The unidirectional locking elements (108) and bidirectional locking elements (108′) may be incorporated into the bores (102) and (106′) in side sections (102) and (106) of connector (100) by an over-molding process that anchors the locking mechanism inside the bores as shown in FIG. 5A; or they may be manufactured as a separate part that is firmly connected, for example by crimping or the use of rivets, to the edge of the side section in such a way that the teeth of the locking element extend into the interior of the bores, as shown symbolically in FIG. 4A.

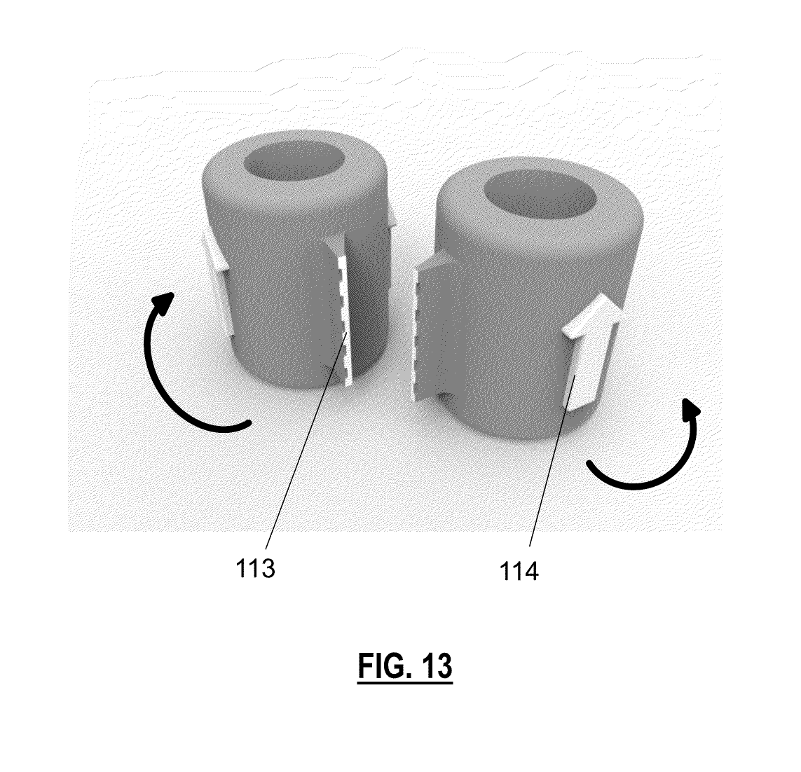

FIG. 13 schematically shows another embodiment of the proposed invention previously showed in FIG. 3 in which the connecting section has a mechanically weak area (113) enabling two bores can be separated by applying a single handed force on the bores such as pinching using one thumb and one or more fingers, or crushing the connector by closing a fist on it and applying force. FIG. 13 also shows an embodiment of tactile markings (114) on the connector to indicate direction of insertion to the bores which can be required due to the nature of using light emitting tubes in dark conditions.

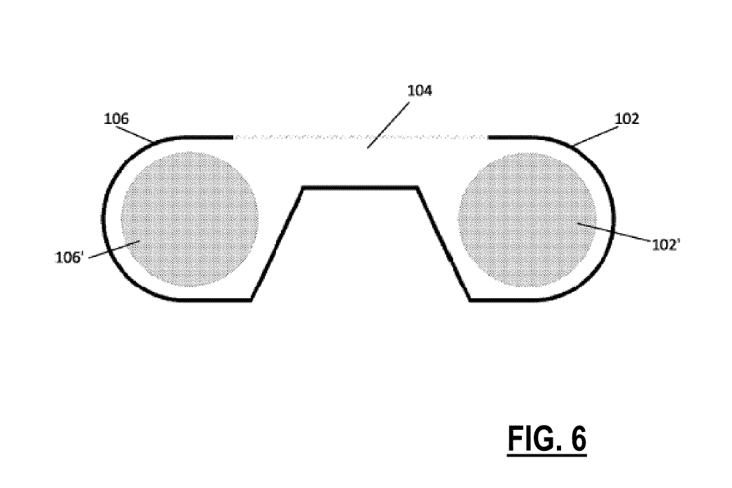

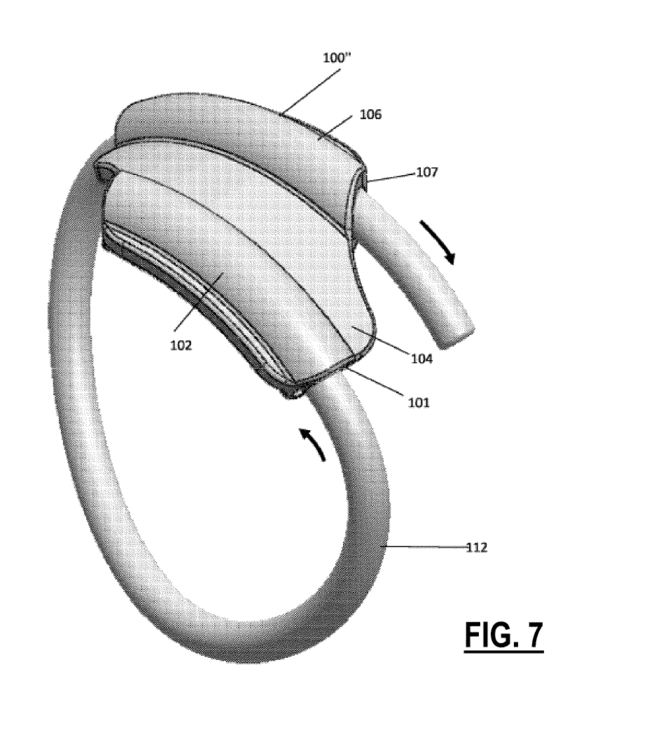

Embodiments of the connector of the invention are made of material that transmits light coming from the portions of the flexible light emitting tube (112) that are located within the bores in the side sections (102) and (106). FIG. 6 symbolically shows an embodiment of the connector in which all parts of the exterior wall except for the top of connecting section (104) are made opaque (indicated by thick dark lines). In this embodiment light from the interior of the connector can escape only through the top of the connecting section thereby enhancing the lighting effect in the connecting section (104) for purposes of displaying information. In these embodiments the information on the connecting section (104) is advantageously implemented by surface engraving, which modifies the optical properties of portions of the surface resulting in contrasting illumination of the engraved symbols/design from the background. FIG. 7 schematically shows an embodiment of connector (100″) of the invention in which the two side sections (102) and (106) and connecting section (104) are elongated and displaced from each other in the axial direction. This embodiment can be used to effectively extend the length of flexible light emitting tube (112) facilitating it's usage as non-removable identification bracelet for a wide variety of wrist sizes, covering the range of human wrist dimensions (average wrist sizes—male 6″-10″; female 5.5″-9.5″). For instance a connector such as that shown in FIG. 7 can be used to form a bracelet for persons having a wrist circumference from approx. 9.5″ to smaller than 7″ using a standard 8 inch glow tube. FIG. 8 symbolically shows an embodiment of the connector (100″) of the invention in which connecting section (104) is attached to side sections (102) and (106) by means of tabs (118) (a minimum of two tabs (118) are needed, three tabs lend more stability to the connector, however more than three tabs can also be used. Other methods of connecting the connecting section to the side sections, for example a continuous band of thin material can be used. The purpose of this embodiment is to allow the connecting section (104) to be separated in one piece from the side sections (102) and (106) when it is desired to remove the bracelet, preferably without the use of tools for example by twisting the side sections and connecting section relative to each other. The connecting section (104) can then be retained by participants as a souvenir of the event that was attended.

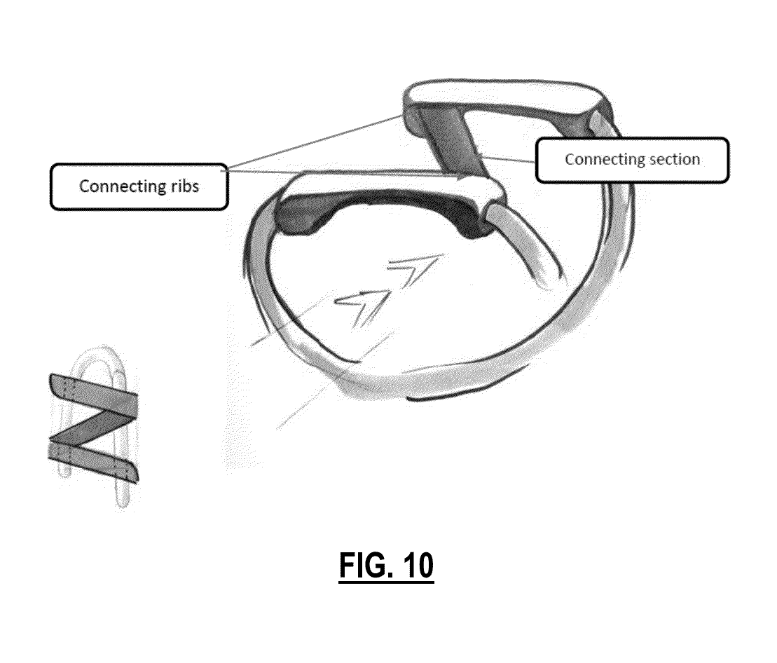

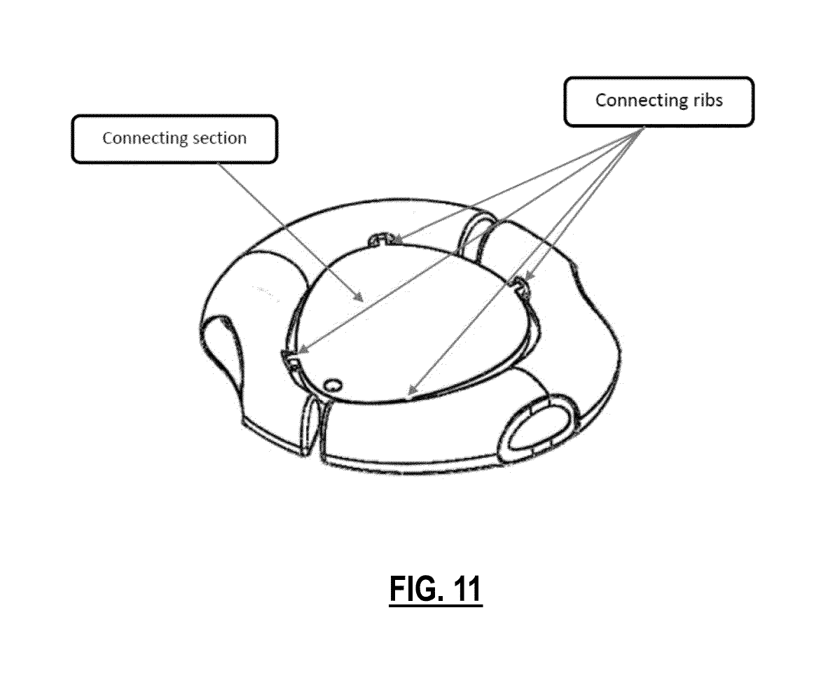

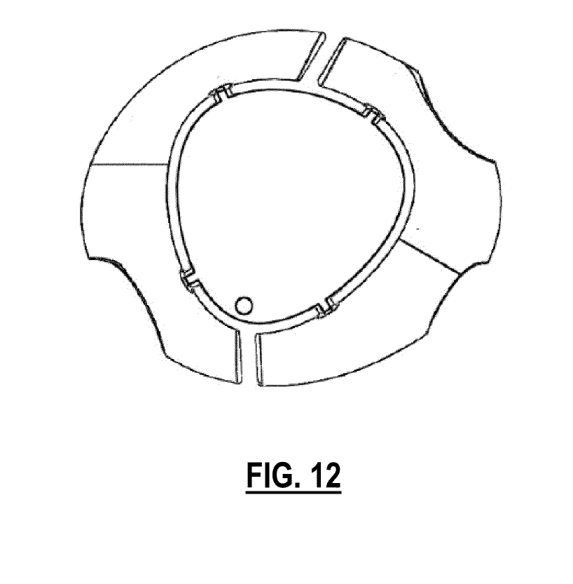

The relatively large planar or near planar surface of the connecting section (104) of the embodiment shown in FIG. 10 provides the opportunity for incorporating advertising or other information that the user can “take home” with him/her after the event. In one embodiment a Near Field Communication (NFC) tag, RFID tag, or other type of radio technology device comprised of a chip with circuitry, encoded data, and an antenna is attached to or embedded in the connecting section (104). For example, the NFC tag on the connecting section can be used to communicate with NFC enabled readers such as smartphones both inside the venue at which an event is being held or outside the venue after the connecting section has been separated from the side sections of the connector.

One of the major advantages of the identification devices of the invention is the ability that they have to be used it as payment verification and luminous color coded identification means. For example, it is very common that venues for mass attended events, such as indoor or outdoor concerts and sporting events are divided into different seating zones depending, for example on location and price of the tickets. These areas can be identified by different colors, for example at an indoor concert: a VIP area close to the stage will cost more and be designated as a “gold zone”); tickets for seating on the ground level beyond the “gold zone” cost less and this area of the venue can be designated the “green zone” and a “red zone” designates the least expensive seats in the balcony. When a person arrives at the site of the performance, she/he will receive a connector of the invention and a flexible light emitting tube having a color that corresponds to the price of his/her ticket. The flexible light emitting tube and connector will be assembled as described herein above to form an armband or bracelet that will have to be visible on the arm in order to enter the venue for the duration of the performance. The staff and security personnel, who have specific tasks or are allowed access to specific areas of the venue, e.g. backstage, will also wear bracelets or armbands of the invention having distinctive colors.

The device of the invention provides several security features, for example:
The structure of the connectors of the invention allows the attached flexible light emitting tube to be bent into a shape that cannot be replicated by buying an off-the-shelf light stick bracelet.
In many venues, such as clubs it is possible for ticket holders to exit and reenter without purchasing new tickets. Using embodiments of the invention in which light radiates from connecting section (104), this privilege cannot be abused by passing the device from someone who has entered the venue to a friend on the outside. This is because the only way to remove the device is to cut the connecting section or the flexible light emitting tube. Reconnecting the parts of the connecting section, e.g. by gluing, will alter the properties of the light emitted in a way that will be easily detected by security personnel.
Another security feature of the invention can be provided by adding proprietary features to the flexible light emitting tube. For example, glow stick manufacturers can supply unique colors which are not available off-the-shelf in party/toy stores and may also provide unique imprints on the outer surface of the light-stick itself, making them impossible to replicate.
The fact that the luminescence decays can guarantee that the user was given the bracelet the same day and also can serve as a measure of the time that the user has worn the bracelet. For example persons such as security/medical personnel, drivers of heavy trucks, or operators of complex industrial equipment whose mental/physical ability to perform their assigned tasks could be reduced to a dangerous level after a given number of hours could be obligated wear a bracelet of the invention, which would serve as a visible reminder to suggest shift replacement.
Implementing RFID/NFC into the connecting section provides the device with multiple verification features unlike any other RFID/NFC enabled identification device due to the color coding and time dependent features.

The security features listed above distinguish the non-removable single use identification bracelets of the invention from prior art illuminated bracelets that can be removed or fall off from the object to which they are attached and reused.

The invention has been described primarily in terms of its function as a security device to identify individuals but it can be used in any and all of the other applications in which light emitting tubes play a role such as adding audience contributed color and excitement to performances, to “color” a stadium or arena with selected color to match a sponsor's or team's proprietary colors, as playthings, as safety devices to warn of cars parked on the side of the road or other obstacles such as fallen trees on a dark night, and wrapped around door handles or bannisters to identify and illuminate exits and stairways.

Another use of the identification devices of the current invention is for identification of security, staff, rescue, or medical personnel in any dark location. This use can be in ordinary situations such as traffic control, in military or police actions, or following man-made or natural disasters such as earthquakes, severe storms, or terrorist attacks. In these cases, the personnel authorized to be present in the area can be identified by their function by distinctively colored bracelets and unauthorized persons will be easily spotted and dealt with by security personnel. In situations where there are mass casualties identification devices of the invention having different colors can be affixed to a limb of the injured persons to indicate the seriousness of the injuries, i.e. severe-RED, mild-GREEN, etc. Because the connector of the present invention allows the flexible light emitting tube to be tightened around the arm of the person, or locked around one of the person's belt loops or any other location there is no possibility of it falling off such as can easily happen with prior art glow stick bracelets, especially when the personnel are very active, for example as is usually the case in emergency situations. Although embodiments of the invention have been described by way of illustration, it will be understood that the invention may be carried out with many variations, modifications, and adaptations, without exceeding the scope of the claims. For example:
Two or more connectors of the invention can be used to connect two or more flexible light emitting tubes in series to form large diameter or multicolored helical-shaped identification devices.
In the embodiment shown in FIG. 2, the end of flexible light emitting tube (112) could be pushed through bore (106′) in connector (100) from end (105) to end (107) resulting in a U shaped loop.
In the embodiment shown in FIG. 3, one end of flexible light emitting tube (112) could be pushed through bore (106′) in connector (100) in the opposite direction to which the other end is pushed through bore (102′) resulting in a helical shaped loop.

Event wristbands containing RFID or NFC chip are widely available and are most commonly used on large events due to their low price and user identification properties. There are generally two types such wristbands—
Non-reusable identification wristbands which need to be cut or torn in order to be removed from the user thus preventing the Wearer from being able to re-use the device or transfer it to a fellow user once it has been separated from the body part or article of apparel. Such wristbands are thrown away once removed since in most cases, the RFID or NFC chip is destroyed as well;
Identification wristbands, which can be removed or transferred to a fellow user, either made from elastic material or simply tied around ones wrist and can be easily removed but since they contain the RFID or NFC chip coded with user specific data, the validity of the user can be checked by scanning the RFID. Since in order to remove this type of wristbands it is not needed to destroy them, they can also be retained by the user and serve as a souvenir from the event.

The present invention describes a non-reusable identification device and more specifically, the proposed invention describes a connecting section of a single-use identification wristband that is used for user-targeted marketing before, during and after the user has attended the event. The proposed invention describes a connecting section that is hinged by connecting ribs to the elements that facilitate locking and/or fitting of the wristband in such a way that breaking one or more of the connecting ribs either by applying sufficient force by hand e.g. twisting, tearing etc. or by sing a cutting tool like scissors to cut the connecting ribs, the wristband is opened and the connecting section is manufactured and designed in a way that it may be retained by the user as a souvenir from the event. The proposed invention further describes that the connecting section which may be retained by the user as souvenir, contains a form of RFID chip (Radio Frequency Identification) such as NFC type, embedded or placed on it with strong adhesive. The chip plays a significant part in this invention since it stores unique user information and is used to identify the user during the event, and can also be used by the sponsor of the event or any other company with interest for targeted audience marketing after the event.

What is claimed is:

1. A connector for connecting, fitting to size, and locking a flexible light emitting tube into a closed loop that is fit around an object, said connector comprising:
a first side section comprising a bore having at least one open end and a locking element located in said bore;
a second side section comprising a bore having two open ends and a locking element located in said bore; and
a connecting section adapted to join said first and said second side sections together;
said connector characterized in that, when a first end of said flexible light emitting tube is inserted into, through, and locked by said locking element in said bore in said first side section, a second end of said flexible light emitting tube can be pushed through said bore in said second side section, thereby reducing the length of the circumference of said loop enabling said loop to fit securely around said object.

2. The connector of claim 1 wherein, when the second end of said flexible light emitting tube is pushed through the bore in the second side section in the opposite direction to which the first end of said flexible light emitting tube was inserted into the bore in the first side section, the loop assumes a helical shape.

3. The connector of claim 1 wherein, when the second end of said flexible light emitting tube is pushed through the bore in the second side section in the same direction to which the first end of said flexible light emitting tube was inserted into the bore in the first side section, the loop assumes a U shape.

4. The connector of claim 1 manufactured from a material that is sufficiently strong such that once the respective ends of the flexible light emitting tube have passed through the locking elements in the respective bores in the first and second side section and said loop is fit securely around said object, the length of the circumference of said loop cannot be increased without destroying said connector, thereby preventing said connector from being reused.

5. The connector of claim 1 manufactured such that the connecting section can be separated from the side sections without the use of tools.

6. The connector of claim 1 wherein the two side sections and connecting section are elongated and displaced from each other in the axial direction.

7. The connector of claim 1 comprising information created on or attached to the surface or embedded in the connecting section.

8. The connector of claim 7, wherein at least a part of the information is embodied in a radio communication technology component.

9. The connector of claim 8, wherein the radio communication technology is one of Near Field Communication (NFC) and Radio Frequency Identification (RFID).

10. The connector of claim 5 wherein the separated connecting section is retained by participants as a souvenir of the event that was attended.

11. A luminous identification device comprised of a flexible light emitting tube and a connector adapted to hold said flexible light emitting tube in a loop, wherein said connector comprises:
a first side section comprising a bore having at least one open end and a locking element located in said bore;—a second side section comprising a bore having two open ends and a locking element located in said bore; and
a connecting section adapted to join said first and said second side sections together;
said luminous identification device characterized in that, when a first end of said flexible light emitting tube is inserted into through and locked by said locking element in said bore in said first side section, a second end of said flexible light emitting tube can be pushed through said bore in said second side section, thereby reducing the length of the circumference of said loop enabling said loop to fit securely around an object.

12. The luminous identification device of claim 11, wherein said device is adapted to be used as a single use payment verification and identification means.

13. The luminous identification device of claim 11, comprising at least two flexible light emitting tubes connected by one connector for each of the at least two tubes.

14. A system for long-term direct marketing and user engagement comprising:
a. A single use identification wristband;
b. A connecting section which contains the user specific data coded on the NFC chip; and
c. Connecting ribs that mechanically joins the connecting section to the wristband in a way that and breaking one or more of the connecting ribs opens the wristband and releases the connecting section to be retained as a souvenir from the event.

15. The connector of claim 5, further manufactured such that the connecting section can be separated from the side sections without the use of tools by applying single handed force on the two bores.
